(19) United States
(12) Patent Application Publication
(10) Pub. No.: US 2002/0059789 A1
(43) Pub. Date: May 23, 2002

(54) Mower-conditioner

(75) Inventor: Maarten Koorn, Schiedam (NL)

Correspondence Address: Penrose Lucas Albright, Esq., MASON, MASON & ALBRIGHT, P.O. Box 2246, Arlington, VA, 22202-0246, US

(73) Assignee: Maasland, N.V., a Dutch Limited Liability Company

(21) Appl. No.: 09/935,547

(22) Filed: Aug. 24, 2001

Related U.S. Application Data
(63) Continuation of application No. PCT/NL00/00849, filed on Nov. 20, 2000.

(30) Foreign Application Priority Data
Jul. 5, 2001 (WO) 01/47343A1
Nov. 20, 2000 (EP) 99204519.5

(51) Int. Cl. A01D 82/00

(52) U.S. Cl. 56/16.4 A

(57) ABSTRACT

Mower-conditioner comprising a mower (1) suspended vertically displaceable on a main frame (10) and a conditioner (2) following the mower (1), adjustably linked to the main frame (10). In order to improve the functioning, particularly the ground adaptation of the mower-conditioner while lessening the construction effort, it is proposed according to the invention that the conditioner (2) be movably coupled via at least one coupling member (19) to the mower (1).

The invention concerns a mower-conditioner comprising a mower suspended vertically displaceable on a main frame and a conditioner following the mower, adjustably linked to the main frame.

Mower-conditioners are suitable and applicable for mowing and subsequent conditioning of the mown material in the interest of more rapid drying. In a known mower-conditioner of this type (EP 0 116 662 A1), the mower is articulated, independently of any subsequent conditioner, vertically displaceable on a main frame. The conditioner may optionally be pivoted relative to the main frame into an inoperative position, although in operation it is firmly assigned to it in that the support arms of the conditioner lie on the upper side of the main frame. In this way, the mower is relieved of the weight of the conditioner. However, this machine arrangement has the following disadvantages:

Since the mower follows unevennesses of the ground in vertically displaceable manner, though not the conditioner, material hand-over from the mower to the conditioner is problematic.

Due to the non-yielding conditioner, the distance between the mower and the conditioner must be large enough that on yielding the mower does not collide with the conditioner.

Due to the relatively large distance between mower and conditioner, this machine combination is relatively long and, due to the long lever arms, requires a sturdier construction of the components.

Mower-conditioners are known (FR 2 560 484 A1) whereby mower and conditioner are constructed as one component and are pivoted to be vertically displaceable as a whole on a main frame with, for instance, parallel guide rods and a weight-relieving spring. Due to the large overall weight, this structural unit reacts to unevennesses of the ground only relatively sluggishly. Furthermore, a complex weight-relieving spring arrangement must be provided to ensure that the spring relief remains nearly constant on the structural unit throughout the lift way.

Starting from this prior art, the object of the invention is to improve the function, particularly the ground adaptation of a mower-conditioner while reducing the design and construction effort involved. This object is achieved according to the invention in that the conditioner is movably coupled to the mower via at least one coupling member.

During operation and particularly where the ground is uneven, the conditioner is adjustable in its position relative to the main frame and to the mower. Due to the jointed coupling of mower and conditioner, the two units adjust together to ground unevenness.

The conditioner can therefore be arranged at a small distance from the mower, as is most favourable for optimum material transfer. Since, in addition, a part of the conditioner weight is borne by the main frame, the mower can, despite the smaller dimensioned weight-relieving spring, adjust more easily and rapidly to ground unevennesses. Also advantageous is the fact that the conditioner places less load on the mower thanks to the articulated connection. Components can be designed lighter.

The arrangement of an articulation axis of the coupling member at small distance from the mowing rotor ensures that the conditioner remains close to the mower despite the pivoting motion.

In a particularly simple embodiment, the coupling member is designed as pivot joint, thus ensuring that the conditioner is liftable with the mower and is simultaneously pivotable, which is particularly important for mowers supported on parallel guide rods.

According to a further feature of the invention, the conditioner is pivotally linked via at least one support element to the main frame, which is rotatably pivoted at one end about at least one upper horizontal joint axis on the main frame and, at the other end, about a lower horizontal joint axis on the conditioner. Thereby, a part of the conditioner weight is borne by the main frame and rearward yielding of the conditioner with the mower is assured.

In order that on uneven ground, the mower and the conditioner adjust as uniformly as possible to the ground unevennesses, the lower joint axis of the support elements and the rotation axis of the conditioner rotor lie approximately in one horizontal plane.

In order to adapt the mower and the conditioner to one-sided ground unevennesses, it is proposed that the conditioner is jointed on the main frame both able to swing about an upper horizontal central longitudinal axis and able to pivot about a horizontal transverse axis on the main frame.

Further features, advantages and structural embodiments of the invention are contained in the subclaims.

The invention will now be described in greater detail with reference to an embodiment contained in the drawings, in which:

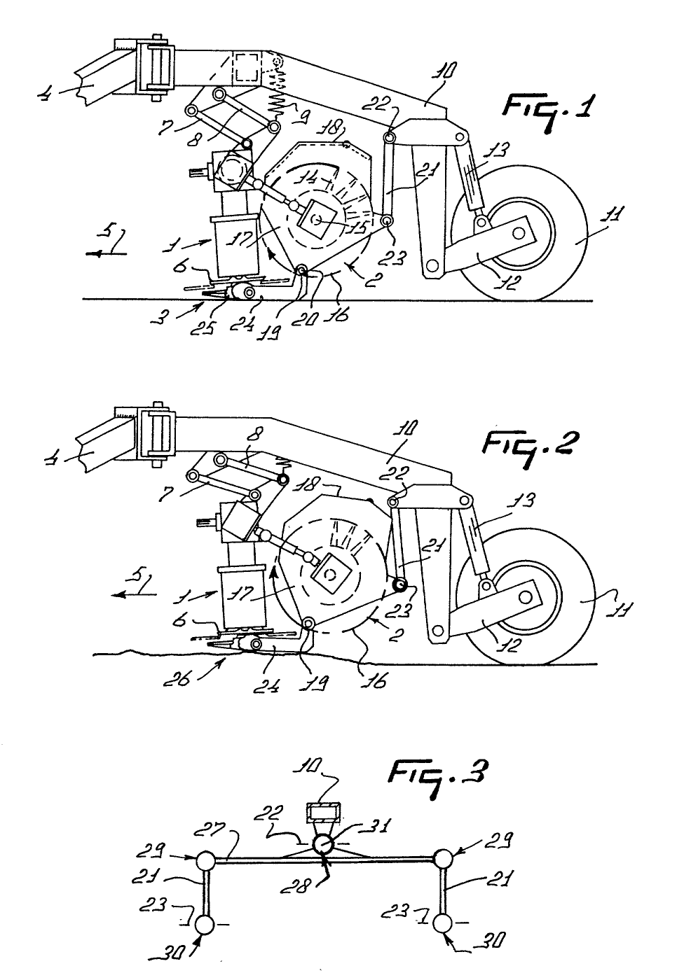

FIG. 1 is a schematic side view of a mower-conditioner in the normal working position,

FIG. 2 is a view according to FIG. 1, but in the raised yielding position of the mower-conditioner when travelling over a ground elevation and

FIG. 3 is an enlarged front view of a second embodiment of a support element for swinging and tilting connection of the conditioner to the main frame.

The mower-conditioner comprises a mower 1 and a conditioner 2 for mown material and can be designed, as shown in FIG. 1, as a towing device. It is drawn in the working position 3 via a drawbar 4 by an agricultural towing vehicle offset from it in the direction of travel indicated by arrow 5 and driven via a universal joint shaft (not shown) from the towing vehicle.

In this example, the mower 1 is designed as a rotary cutter of traditional design with mower rotors 6. The mower 1 is pivoted to a main frame 10 via parallel linkage rods 7, 8 and weight relief springs 9 movable up and down.

On the main frame 10, the drawbar 4 is pivoted articulated and adjustable in its pivot position via a compressed medium drive (not shown). Running wheels 11 are provided on both sides, supporting the main frame 10 against the ground. The wheels 11 are rotatably attached to the rear ends of longitudinal linkage rods 12. The front ends of the longitudinal linkage rods 12 are rotatably pivoted to the main frame 10. The main frame 10 is adjustable in its vertical position relative to the ground by means of hydraulic cylinders 13. The hydraulic cylinders 13 engage, on one side, with the main frame 10 and, on the other side, with the longitudinal linkage rods 12.

The conditioner 2 has a tined rotor 14 which runs around a horizontal rotary axis 15 lying transverse to the direction of travel 5 driven to rotate in the direction of the arrow 16. The tined rotor 14 is mounted on both sides in side walls 17 linked by transverse struts (not shown) and covered above by a cover 18. Further details of the design of a conditioner 2 are not given here, since these are known in principle.

What is new is the articulated coupling of the conditioner 2 to the mower 1. The coupling is so designed that the conditioner 2 necessarily follows the movements of the mower 1 without substantially altering its position relative to the mower 1. The conditioner 2 is coupled to the mower 1 on the side towards the mower on both external sides with, in each case, a pivot joint 19 with horizontal transverse axis 20 situated immediately behind and laterally outside the rotational path of the outer mower rotor 6. On the side facing away from the mower 1, the connection is made with upwardly directed linkage rods 21 loaded with respect to traction which are pivoted about an upper horizontal joint axis 22 on the main frame 10 and about a lower horizontal joint axis 23 on the conditioner 2 or on its side walls 17. Both joint axes 22, 23 are arranged parallel to the transverse axis 20. On both sides of the mower 1, corner brackets 24 are attached, whose upward pointing legs 25 are designed as double strap with one bore each. Each double strap accepts within it a side wall 17 with an equally large bore. The articulated connection takes place with a securing bolt (not shown) passing through all three bores. The joint axes 22, 23 are arranged parallel to the transverse axis 20. In order that the conditioner 2 changes its position in relation to the mower 1 as little as possible on encountering ground unevennesses, the lower joint axis 23 lies at approximately the same height from the ground as the pivot axis 15. In order to effect relief of the mower 1 from the weight of the conditioner 2, the pivot joint 19 is offset by a distance forwards relative to the pivot axis 15, so that the pivot joint 19 has a greater separation from the joint axis 23 than the pivot axis 15. In order to achieve adaptation of the mower 1 and the conditioner 2 in the event of one-sided ground unevennesses, both the parallel linkage rods 7, 8, the pivot joint 19 and the linkage rods 21 may be provided with ball joints (not shown). As an alternative to two linkage rods 21, just one linkage rod (not shown) may be provided centrally, engaging above by means of a ball joint with the main frame 10 and below by means of a ball joint with the conditioner 2.

During operation, the mower 1 slides on slide elements 25 over the ground and can adapt to all ground unevennesses. During this movement, the conditioner 2 is also forcibly turned relative to the mower 1, so that in every operating condition a good flow of material via the shortest route from the mower 1 to the conditioner 2 is assured. As can be seen from FIG. 2, in which the mower 1 is shown in raised yielding position 26 due to a ground elevation, the conditioner 2 swings in clockwise direction during lifting of the mower 1 and simultaneously, via the joint axes 22, 23 of the linkage rods 21, backwards. Thus the conditioner 2 follows the movements of the mower 1 according to this parallel linkage rod arrangement 7, 8 and remains at almost constant distance from the ground. In relation to mower-conditioners that are pivotable as a whole, the design according to the invention can not only be dimensioned lighter, but also adapts more rapidly and easily to all ground unevennesses.

FIG. 3 schematically shows only a U-shaped support element comprising a support beam 27, which engages centrally via a single ball joint 28 on the main frame 10 and is also linked on both sides to the linkage rods 21 via ball joints 29. The linkage of the conditioner 2 to the linkage rods 21 also takes place unchanged via ball joints 30. By means of a simple design measure, this design allows a rolling adaptation of the conditioner about a horizontal longitudinal central axis 31 and simultaneously about the horizontal transverse axis 22, as well as adaptation in the case of one-sided unevennesses.

Within the scope of the invention, the mower may also be designed as a drum mower or as a combination of rotors and drum mowers. Similarly, press roller conditioners or other conditioning elements may be employed.

1. Mower-conditioner comprising a mower (1) suspended vertically displaceable on a main frame (10) and a conditioner (2) following the mower(1), adjustably linked to the main frame (10), characterised in that the conditioner (2) is movably coupled to the mower (1) via at least one coupling member (19).

2. Mower-conditioner according to claim 1, characterised in that the coupling member is a pivot joint (19).

3. Mower-conditioner according to claim 1 or 2, characterised in that a joint axis (20) of the coupling member (19) is arranged at a small distance to the mower rotor (6).

4. Mower-conditioner according to claim 1, 2 or 3, characterised in that the coupling member has a sliding guide.

5. Mower-conditioner according to claim 1, 2 or 3, characterised in that the coupling member is an intermediate piece with separated joint axes, which engages articulately both on the mower (1) and on the conditioner (2).

6 Mower-conditioner according to one of the claims 1 to 5, characterised in that the coupling member has ball joints.

7. Mower-conditioner according to one or more of the previous claims, characterised in that on each side of the mower (1) a coupling member (19) is provided for the conditioner (2).

8. Mower-conditioner according to one or more of the previous claims, characterised in that the joint axis (20) of the coupling member (19) is arranged parallel to the rotation axis (15) of a conditioner rotor (14) of the conditioner (2).

9. Mower-conditioner according to one or more of the previous claims, characterised in that the conditioner (2) is pivotally linked via at least one support element (21, 27) to the main frame (10), which is rotatably pivoted at one end about at least one upper horizontal joint axis (22) on the main frame (10) and, at the other end, about at least one lower horizontal joint axis (23) on the conditioner (2).

10. Mower-conditioner according to claim 9, characterised in that the support element is a single linkage rod arranged centrally on the conditioner (2).

11. Mower-conditioner according to claim 9, characterised in that the support element is formed by two linkage rods (21) arranged in a distance side by side.

12 Mower-conditioner according to claim 11, characterised in that the linkage rods (21) are linked above by joints (29) with a support beam (27) which is suspended by at least one joint (28) centrally on the main frame (10).

13. Mower-conditioner according to one of the claims 9 to 12, characterised in that the conditioner (2) is jointed on the main frame (10) both able to swing about an upper horizontal longitudinal central axis (31) and able to pivot about a horizontal transverse axis (22).

14. Mower-conditioner according to one or more of the claims 9 to 13, characterised in that all couplings between main frame (10) and support elements (21, 27) and between support element (21) and conditioner (2) are designed as ball joints (28, 29, 30).

15. Mower-conditioner according to one or more of the previous claims, characterised in that on raising of the mower (1) out of a normal working position (3) into a shifting position (26), the conditioner (2) is pivoted relative to the mower (1) in the rotation direction (16) of the conditioner rotor (14).

16. Mower-conditioner according to one or more of the claims 9 to 15, characterised in that the lower joint axis (23) of the support elements (21, 27) lies—seen in the direction of travel (5) behind the rotation axis (15) of the conditioner rotor (14).

17. Mower-conditioner according to one or more of the claims 9 to 16, characterised in that the lower joint axis (23) of the support elements (21, 27) and the rotation axis (15) of the conditioner rotor (14) lie approximately in one horizontal plane.

18. Mower-conditioner according to one or more of the previous claims 9 to 17, characterised in that the support elements (21) are arranged directed upwards from their joint axis (23) lying on the conditioner (2).

19. Mower-conditioner according to one of the previous claims, characterised in that the distance of the coupling member (19) from the joint axis (23) of the support elements (21, 27) is greater than the distance of the rotation axis (15) of the tined rotor (14) from the joint axis (23).

20. Mower-conditioner according to one or more of the previous claims, characterised in that the mower (1) is linked via a weight-relieving spring (9) and parallel linkage rods (7, 8) to the main frame (10).

21. Mower-conditioner according to one or more of the previous claims, characterised in that the main frame (10) is designed capable of being raised and lowered with at least one hydraulic cylinder (13) and has a pivotable and fixable drawbar (4).
